(19) United States
(12) Patent Application Publication
(10) Pub. No.: US 2004/0020674 A1
(43) Pub. Date: Feb. 5, 2004

(54) Composite EMI shield

(75) Inventors: Jeff McFadden, Blairstown, NJ (US); Martin Rapp, Grover, MO (US)

Correspondence Address: TESTA, HURWITZ & THIBEAULT, LLP, HIGH STREET TOWER, 125 HIGH STREET, BOSTON, MA, 02110, US

(73) Assignee: LAIRD TECHNOLOGIES, INC., DELAWARE WATER GAP, PA

(21) Appl. No.: 10/461,930

(22) Filed: Jun. 13, 2003

Related U.S. Application Data
(60) Provisional application No. 60/388,865, filed on Jun. 14, 2002.

(51) Int. Cl. H02G 3/00

(52) U.S. Cl. 174/35 MS

(57) ABSTRACT

Electrically conductive materials can be used to shield EMI, whereas energy-absorptive materials can be used to suppress EMI. Disclosed are systems and processes for combining electrically conductive and absorptive materials to improve EMI shielding effectiveness. In one embodiment, an absorptive material is combined with the conducting material forming a composite. In another embodiment, absorptive material is combined with electrically conductive material and selectively applied to a substrate, such as a plastic enclosure, to suppress EMI incident upon the substrate, thereby reducing the susceptibility of electronics contained within across a broad frequency range.

### CROSS-REFERENCE TO RELATED APPLICATION

This application claims priority to and incorporates herein by reference in its entirety U.S. Provisional Application Serial No. 60/388,865, filed on Jun.14, 2002, entitled Composite EMI Shield.

### FIELD OF THE INVENTION

The present invention relates generally to electromagnetic shielding and, more particularly, to electromagnetic shielding incorporating both reflective and absorptive properties to improve shielding effectiveness.

### BACKGROUND OF THE INVENTION

As used herein, the term electromagnetic interference (EMI) should be considered to refer generally to both electromagnetic interference and radio frequency interference (RFI) emissions, and the term“electromagnetic” should be considered to refer generally to electromagnetic and radio frequency.

During normal operation, electronic equipment typically generates undesirable electromagnetic energy that can interfere with the operation of proximately located electronic equipment due to EMI transmission by radiation and conduction. The electromagnetic energy can exist over a wide range of wavelengths and frequencies. To minimize the problems associated with EMI, sources of undesirable electromagnetic energy may be shielded and electrically grounded. Alternatively, or additionally, electronic equipment susceptible to EMI may be similarly shielded and electrically grounded. Shielding is designed to prevent both ingress and egress of electromagnetic energy relative to a barrier, a housing, or other enclosure in which the electronic equipment is disposed. Effective shielding is often difficult to attain, because such enclosures often include gaps or seams, for example between adjacent access panels and around doors, or between component housings and circuit boards, permitting the transference of EMI therethrough. Further, in the case of electrically conductive metal enclosures, these gaps can inhibit the beneficial Faraday Cage Effect by forming discontinuities in the conductivity of the enclosure which compromise the efficiency of the ground conduction path through the enclosure. Moreover, by presenting an electrical conductivity level at the gaps that is significantly different from that of the enclosure generally, the gaps can act as slot antennae, resulting in the enclosure itself becoming a secondary source of EMI.

Shields are generally constructed to reduce EMI at a particular wavelength, or range of wavelengths. EMI shields are typically constructed of a highly-conductive material operating to reflect the radiation component of the EMI and to drain to electrical ground the conducted component of the EMI. For example, EMI shields are typically constructed of a sheet metal, such as copper, aluminum, and/or steel. EMI shields may also be constructed of combinations of different metals, such as copper, aluminum, or steel coated with another material, such as nickel, tin, and/or gold, and combinations of a conductive material with an electrical insulator, such as metal-plated plastic.

In the abstract, an ideal EMI shield would consist of a completely enclosed housing constructed of an infinitely-conductive material without any apertures, seams, gaps, or vents. Practical applications, however, result in an enclosure constructed of a finitely-conducting material and having some apertures. Generally, reducing the largest dimension (not merely the total area) of any aperture, as well as reducing the total number of apertures, tends to increase the EMI protection or shielding effectiveness of the enclosure. Apertures may be intentional, such as those accommodating air flow for cooling, or unintentional, such as those incident to a method of construction (e.g., seams). Special methods of manufacture may be employed to improve shielding effectiveness by welding or soldering seams, or by milling a cavity within a contiguous member of shielding material. The shielding effectiveness of an EMI enclosure having an aperture is a function of the wavelength of the EMI. Generally, the shielding effectiveness is improved when the largest dimension of the aperture is small compared to the wavelength (i.e., less than 1/20^{th} of the wavelength). As the frequencies of operation increase, however, the associated wavelengths of induced EMI decrease, leading to a reduction in shielding effectiveness for any non-ideal EMI enclosure.

Unfortunately, shielding effectiveness of long-proven methods and materials decreases with increasing frequency. Effectively shielding EMI in many of today's electronic applications is becoming more challenging as current trends continue to increase operational frequencies. For example, microprocessor clocking rates used within currently available consumer electronics, such as personal computers, are operating at thousands of megahertz (MHz). Later generation devices are expected operate at even greater frequencies.

As the frequency of operation increases into the gigahertz (GHz) range, and beyond, the shielding effectiveness of standard materials and methods decrease, trending towards zero for many presently-available shielding alternatives. The reduction in shielding effectiveness at higher frequencies is due in part to construction gaps and seams becoming more efficient radiators as the wavelengths of the resulting EMI become smaller (e.g., a wavelength of approximately 1 centimeter results from an operational frequency of 30,000 MHz). Techniques to reduce and virtually eliminate these gaps and seams include welding joints, and milling cavities from contiguous members of shielding material. Although somewhat effective, these techniques are often cost prohibitive, or impractical for other reasons, such as size or weight. Additionally, the shielding effectiveness of realizable conductive material, i.e., material having a finite conductivity, tends to be reduced as frequency increases, even in the absence of gaps or seams. Notwithstanding any seams or openings, a finitely conductive material itself will allow a portion of incident electromagnetic energy to pass through it, because the material is neither a perfect reflector nor a perfect absorber. The absorptive loss, for example, can be defined as A_{dB}=Kₐt(μσF)^{0.5} which will result in a non-infinite absorption (A_{dB}) increasing with frequency (F) for a material of thickness (t) having a relative permeability (μ) and a finite relative conductivity (σ).

Generally, the total loss in a material is made up of the dielectric loss (from polarization) and the conductive (ohmic) loss.

$${ϵ}_{i}^{″} = {ϵ}^{″} + \frac{σ}{ϖ {ϵ}_{0}} \qquad ( 1 )$$

The dielectric constant of a material can be written in complex form,

∈=∈′+j∈″ (2)

in which the real component, ∈′, is the permittivity, and the imaginary component, ∈″, is the loss factor. Further, the ratio of ∈″/∈′ is often referred to as the loss tangent.

There exist certain methods for providing EMI shielding to electronic components. See for example, U.S. Pat. No. 5,639,989 issued to Higgins, III, the disclosure of which is herein incorporated by reference in its entirety. Higgins discloses the use of a housing wherein all interior surfaces are conformally coated with a first EMI material consisting of a polymer containing filler particles. The method disclosed in Higgins applies the first EMI material as a conformal coating. The disclosed method also indicates that selection of different materials for filler particles results in the attenuation of electromagnetic energy within specified frequency ranges.

### SUMMARY OF INVENTION

In general, the present invention relates to a composite EMI shield, such as a highly-conductive metal or other electrically conductive material in combination with an electromagnetic energy-absorbing material to both reflect and absorb a portion of the EMI, thereby enhancing the performance of the EMI shield over a range of operational frequencies. The absorbing material may remove a portion of the EMI from the environment through power dissipation resulting from loss mechanisms. These loss mechanisms include polarization losses in a dielectric material and conductive, or ohmic, losses in a conductive material having a finite conductivity Applying the absorbing material in localized regions near components or electrical circuits may reduce the overall electromagnetic compatibility performance of a device.

In one aspect, the invention relates to a broadband electromagnetic interference (EMI) shielding composite. The EMI shielding composite includes a conductive material for shielding EMI by conducting at least a portion of incident EMI, and an electromagnetic-energy absorptive material for shielding EMI by absorbing at least a portion of the incident EMI. The absorptive material is combined with the conductive material, such that each material retains its identity, while contributing to overall EMI shielding performance.

The conductive material may be an electrically conductive material. In some embodiments, the conductive material and the absorptive material can form respective layers in a predetermined pattern. At least one of the layers can be selectively deposited on a surface of a substrate. For example, at least one of the deposited layers can be screen printed onto the substrate. A remaining layer is selectively deposited on at least one of the surfaces of the substrate and the deposited layer. In some embodiments, at least a portion of each of the conductive material layer and the absorptive material layer is exposed. At least one of the deposited layers can also be formed-in-place on the substrate.

The composite can include particles of the conductive material and particles of the absorptive material combined in a binder matrix material. The matrix material generally supports the combined conductive particles and absorptive particles. The matrix can be an epoxy, various polymers, silicone, rubber, ethylene propylene diene monomer (EPDM), fluorosilicone, polyoxypropylene (POP), open-cell foam, closed-cell foam, fabric, and combinations thereof.

The composite can also be selectively deposited on a surface of a substrate. The energy absorptive material can be carbon-impregnated rubber, ferrite, iron, iron silicide, graphite, carbon in an organic-based carrier, paste composites, and combinations thereof. Further, the conductive material can be silver, nickel, copper, aluminum, steel, silver/glass, graphite, carbon, conductive polymers, and combinations thereof. The composite can be formed as an EMI shield having a shielding effectiveness of at least about 5 dB in a frequency range up to at least about 100 GHz.

In another aspect, the invention relates to a method for preparing a broadband electromagnetic interference (EMI) shielding composite including the steps of providing a conductive material for shielding EMI by conducting at least a portion of incident EMI, providing an electromagnetic energy absorptive material for shielding EMI by absorbing at least a portion of the incident EMI, and combining the absorptive material with the conductive material. In the combination, each material retains its identity, while contributing to overall EMI shielding performance.

In some embodiments, the step of providing an electromagnetic energy absorptive material includes the steps of providing a compressible dielectric matrix, providing an electromagnetic energy absorptive particles, and applying the electromagnetic energy absorptive particles to the compressible dielectric matrix.

The step of applying the electromagnetic energy absorptive particles can include spraying the electromagnetic energy absorptive particles onto the compressible dielectric matrix. Alternatively or additionally, the step of applying the electromagnetic energy absorptive particles can include dipping the compressible dielectric matrix into a bath including the electromagnetic energy absorptive particles. Still further, the step of applying the electromagnetic energy absorptive particles can include combining the dielectric matrix in a preformed state with the energy absorptive particles onto the compressible dielectric material matrix and forming the combination into a compressible electromagnetic energy absorbing material.

In other embodiments, the step of combining the absorptive material with the conductive material includes applying a second layer of one of the conductive material and electromagnetic energy absorptive material to the surface of a first layer of the other one of the conductive material and electromagnetic energy absorptive materials.

In yet another aspect, the invention relates to a broadband EMI shielding composite including a compressible electromagnetic-energy absorber for shielding incident EMI by absorbing at least a portion of the EMI, and a flexible conductor coupled to the absorber for shielding EMI by conducting at least a portion of incident EMI. In some embodiments, the flexible conductor includes a conductive fabric. For example, the conductive fabric can be a woven fabric, a non-woven fabric, a ripstop fabric, a taffeta, and combinations of any of these types of fabrics.

### BRIEF DESCRIPTION OF THE DRAWINGS

The invention is pointed out with particularity in the appended claims. The advantages of the invention may be better understood by referring to the following description, taken in conjunction with the accompanying drawing, in which:

FIGS. 1A and 1B are schematic drawings depicting cross-sectional views of embodiments of a composite-EMI shield;

FIGS. 2A and 2B are schematic drawings depicting cross-sectional views of an alternative embodiment of the invention, in which an absorptive material and a conductive material are combined in a matrix and applied to a substrate;

FIGS. 3A through 3C are schematic drawings depicting cross-sectional views of alternative embodiments of exemplary layering schemes of the materials depicted in FIGS. 1 and 2;

FIGS. 4A and 4B are schematic drawings depicting cross-sectional views of alternative embodiments of the invention in which the absorptive and conductive materials are combined in a single medium;

FIGS. 5A-5E are schematic drawings depicting an embodiment of the invention applying the composite materials to cylindrical structures;

FIGS. 6A and 6B are schematic drawings depicting an alternative embodiment of the invention depicted in FIGS. 5A-5E;

FIGS. 7A and 7B are schematic drawings depicting an embodiment of the invention in which the composite materials are formed as gaskets;

FIGS. 8A and 8B are schematic drawings depicting embodiments of the invention depicted in FIGS. 2A and 2B, in which an absorptive material is selectively applied to a conductive layer on a substrate;

FIGS. 9A and 9B are schematic drawings depicting an embodiment of the invention applying the composite materials to fabric structures; and

FIG. 10 is a graph depicting test measurement results of the shielding effectiveness for an exemplary sample of an EMI shield in accordance with the invention.

### DETAILED DESCRIPTION OF THE INVENTION

In general, a composite material can be composed of two or more substances having different physical characteristics, in which each substance retains its identity while contributing desirable properties to the whole. Composite materials can be formed using one or more absorbing substances having electromagnetic-energy absorbing properties in combination with one or more conducting substances having electromagnetic-energy conductive properties, the resulting combination suppressing EMI transmissions over a broad range of frequencies. Such composite EMI shielding materials can provide substantial electromagnetic shielding effectiveness, for example, up to about 5 dB or more at EMI frequencies occurring up to about 100,000 MHz. Conductive materials can suppress radiated EMI transmissions by reflecting electromagnetic energy incident upon them. Conductive materials can also suppress conducted EMI transmissions by directing electrical current flow induced by the electromagnetic energy along a preferred path. In one embodiment, conductive materials can be composed of highly-conductive materials having an electrical resistivity less than about 0.1 ohm/square. The conductive material may include gold, silver, nickel, copper, aluminum, tin, brass, conductive polymers, silver/glass, graphite, carbon, and combinations thereof. The conductive material may be formed as a metal foil, metal deposited on a substrate, particles within a matrix, and a mix of conductive fibers (e.g., silver/nylon or nickel/nylon).

The electromagnetic fields can induce currents to flow within the absorptive material exhibiting a complex permittivity resulting in dielectric and/or ohmic losses. The absorptive material may exhibit a complex permeability, or magnetic properties, in addition to dielectric properties. For example, absorptive materials can have magnetic properties with relative permeabilities of greater than about 10 at low frequencies and magnetic loss tangents of greater than about 0.5. These magnetic materials also exhibit dielectric properties with relative permittivities which can exceed 50 and a corresponding loss tangent of greater than about 0.2. In one particular embodiment, the absorptive material has a relative magnetic permeability greater than about 3.0 at approximately 1.0 GHz, and greater than about 1.5 at about 10 GHz.

Some examples of absorptive materials include carbon, iron, carbonyl iron powder, sendust, ferrites, iron silicide, magnetic alloys, magnetic flakes, steel wool, and combinations thereof. Other examples of lossy materials include carbon-impregnated rubber, materials in an organic-based carrier, such as ferrite, iron, iron silicide, graphite, and carbon, metal particles and metal clad particles (i.e., iron, nickel, and iron/nickel compositions), and paste composites with different combinations of iron, nickel, and copper with epoxy and lacquer binders. In one embodiment, the absorptive material can be composed of ferrite-like material mixed in an elastomer, or resin binder. The absorptive materials, sometimes referred to as lossy materials, can be prepared in solid form (e.g., a sheet) or in a liquid form, such as a paste for coating a substrate.

Various U.S. patents describe lossy materials and their uses. See, for example, U.S. Pat. No. 4,408,255 issued to Adkins, U.S. Pat. No. 5,689,275 issued to Moore et al., U.S. Pat. No. 5,617,095 issued to Kim et al., and U.S. Pat. No. 5,428,506 issued to Brown et al., the disclosures of which are herein incorporated by reference in their entirety. Some manufactures of lossy materials are R&F Products of San Marcos, Calif.; ARC Technical Resources, Inc. of San Jose, Calif.; Tokin America, Inc. of Union City, Calif.; Intermark-USA, Inc. of Long Island City, N.Y.; TDK of Mount Prospect, Ill.; and Capcon of Inwood, N.Y.

According to the present invention, EMI shielding can be formed as a composite of conductive and absorptive materials. Generally, the resulting composite shield includes a solid material composed of two or more constituent materials having different physical characteristics (e.g., a conductor and an absorber) in which each constituent material retains its identity while contributing desirable properties to the whole. For example, a composite may include multiple layers of each constituent material with distinct boundaries between each layer. Alternatively, a composite may include a single layer in which the constituent materials are intermixed. In either case, the constituent structural material may include one or more of the constituent materials embedded within a third material.

EMI shielding can be added to newly fabricated or existing packages, or housings, for electronic components by applying a first, high-frequency, absorbing EMI material to a second, reflecting EMI material. The high-frequency absorbing material includes a lossy material. In some embodiments that lossy material is broad band in nature, absorbing EMI energy over a broad range of frequencies. The reflecting EMI material can be any of the EMI shielding materials, such as sheet metal, currently used by those skilled in the art.

The constituent materials forming a composite EMI shield may be combined in a number of ways. For example, the constituent materials may be applied, one to another, or either to a substrate, by methods of coating, including laminating, screen printing, and robotic deposition. In one embodiment, the absorptive, or lossy material can applied selectively to a conductive EMI shield, for example, in areas of high emission.

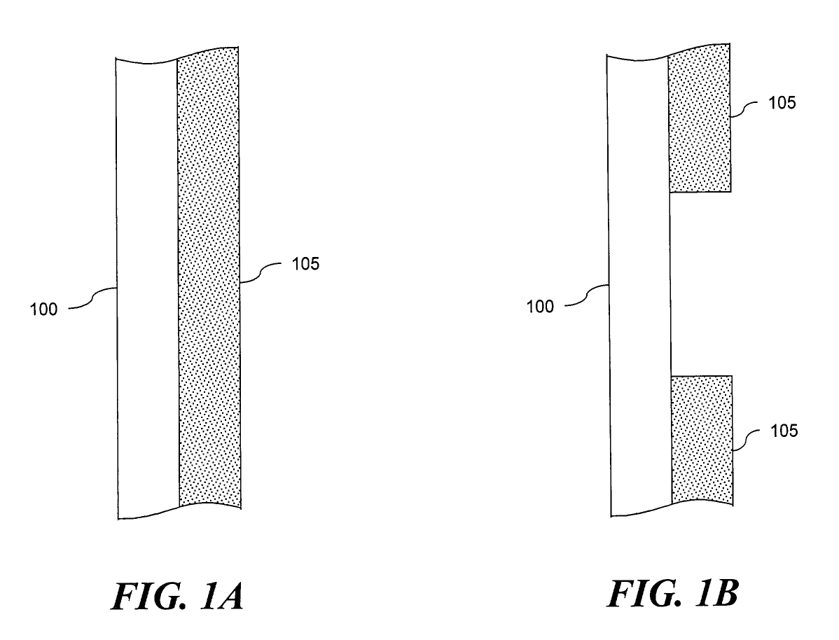

FIG. 1A illustrates a cross-sectional view of one embodiment of a composite EMI shield including a layer of conductive material 100 in combination with a layer of absorptive material 105. As shown, each layer shares a common boundary. In this embodiment, the absorptive, or lossy, material 105 is applied to the conductive, or reflective material 100 using any of the above-mentioned techniques, including an adhesive, such as a non-conducting, pressure sensitive adhesive. Other configurations are possible including combinations of conductive and absorptive layers 100, 105. For example, an absorptive layer 105 may be applied to either side of a conductive layer 100. Yet other configurations are possible including multiple layers of one or more of the materials 100, 105 in which the multiple layers are formed of different materials. For example, the conducting layer 100, may itself be formed of multiple layers, such as nickel-coated brass. Multiple absorptive layers 105 may similarly configured, being selected from different lossy materials.

FIG. 1B illustrates a cross-sectional view of a similar composite EMI shield in which a layer of absorptive material 105 is selectively applied a conductive layer 100. The absorptive layer 105 may be selectively applied to predetermined localized regions of the conductive layer 100, for example to shield against localized EMI. A localized absorptive layer 105 may be formed into a pattern over one or more electrical components or circuits of a circuit board. For example, an absorptive layer 105 may be selectively applied a conductive shield layer 100 to absorb electromagnetic energy generated by radiating components of a handheld communications device, thereby protecting a user from unnecessary exposure to EMI.

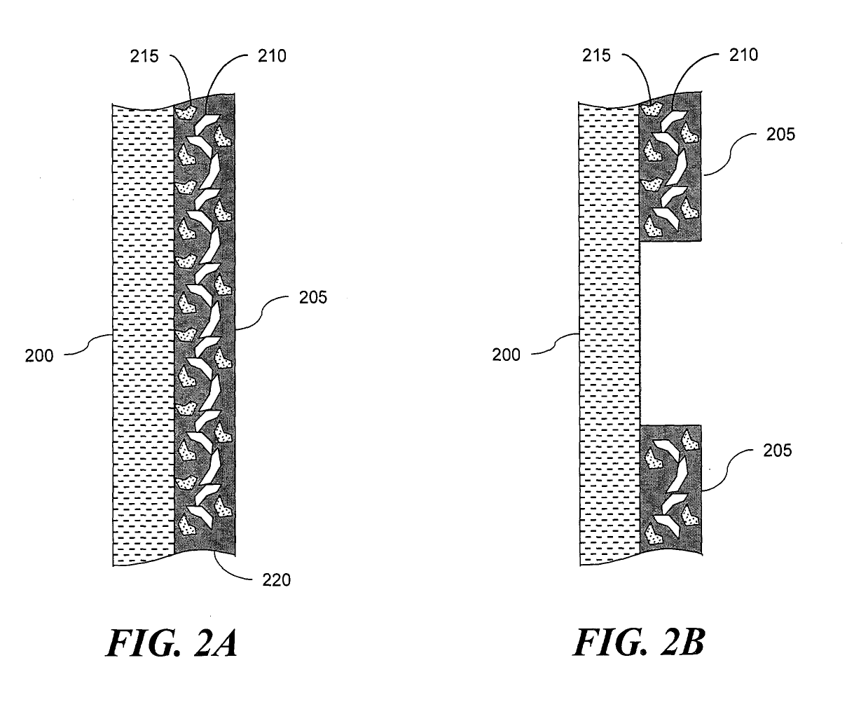

FIG. 2A illustrates a cross-sectional view of a composite material 205 layer applied to a substrate 200 layer. The substrate layer 200 serves to support the composite layer 205 and may be composed of virtually any structurally suitable material, such as a dielectric (e.g., glass, plastic, ceramic, foamed polymers), an electrical conductor (e.g., any of the materials suitable for the conductive layer 100), a magnetic material (e.g., ferrite, iron, iron silicide), or combinations of these material. The composite layer 205 includes both conductive particles 210 and absorptive particles 215. The constituent materials 210, 215 may be bound by a third material serving as a matrix 220. The conductive particles 210 and absorptive particles 215 may be formed as granules (including, for example, particles, spheres, and nanoparticles) or as fibers. The matrix 220 may be an elastomer, a laminate, a fabric, an open-cell, or closed-cell foam, or a polymer. In some embodiments, the conductive particles 210 generally maintain physical contact with neighboring conductive particles 210, thereby forming electrically-conductive paths. Conversely, the absorptive particles 215 may maintain physical contact with local neighboring absorptive particles 215, they generally do not maintain physical contact with neighboring absorptive particles 215 in a continuous manner bridging across a cross-sectional diameter. Such a suitably-formed absorptive material avoids electrically-conductive paths through the absorptive particles (e.g., across the cross-sectional diameter).

In other embodiments in which the matrix 220 is compressible, the conductive particles 210 do not necessarily maintain physical contact with neighboring conductive particles 210 unless the matrix 220 is configured in a compressed state. FIG. 2B illustrates a cross-sectional view of a configuration in which the composite material 205 is selectively applied to the substrate 200, as previously described in relation to FIG. 1B.

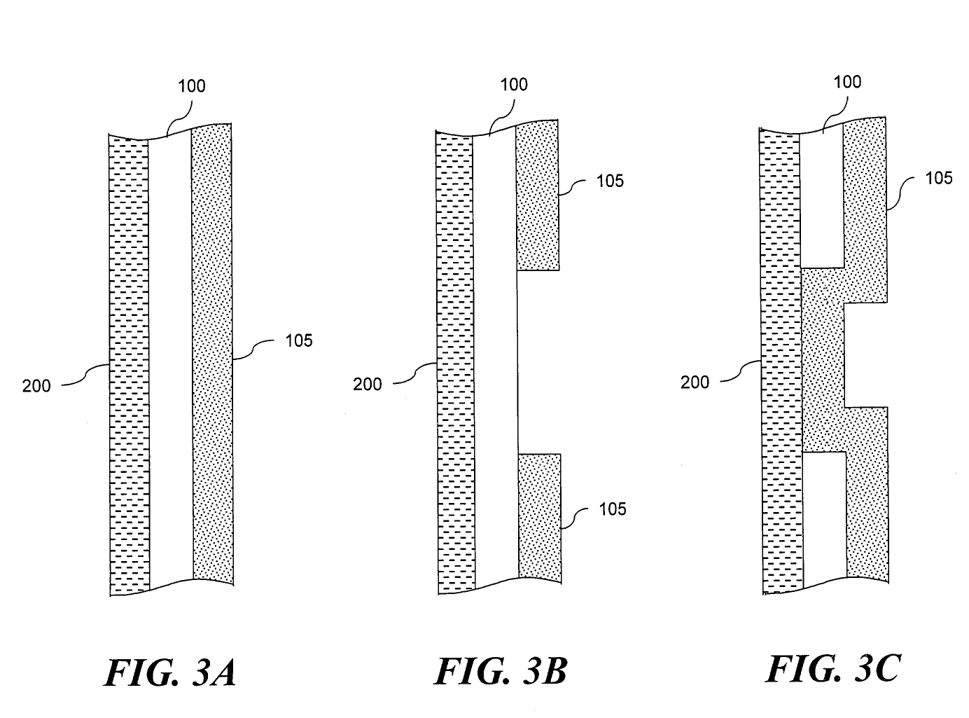

FIGS. 3A through 3C illustrates cross-sectional views of alternative embodiments in which the conductive layer 100 and absorptive layer 105 discussed in relation to FIGS. 1A and 1B are combined with a substrate 200 as discussed in relation to FIGS. 2A and 2B. FIG. 3A illustrates a uniform application, or substantially complete coating, of the absorptive layer 105 to the conductive layer 100 and a similarly uniform application, or substantially complete coating, of the conductive layer 100 to the substrate 200. For example, the substrate 200 may be a plastic equipment case coated with a conductive layer 100, such as a metal foil, a conductive elastomer, paint, or plating additionally coated with an absorptive layer 105. FIGS. 3B and 3C illustrate embodiments in which one or more of the material layers 100, 105 are selectively applied to the substrate 200. As shown in FIG. 3C, at least one of the layers 100, 105 may be selectively deposited upon the substrate 200. A selective deposition of the layers 100, 105 on the substrate may be accomplished by numerous techniques including coating, screen printing, selective plating, selective catalyzation, robotic deposition, or etching.

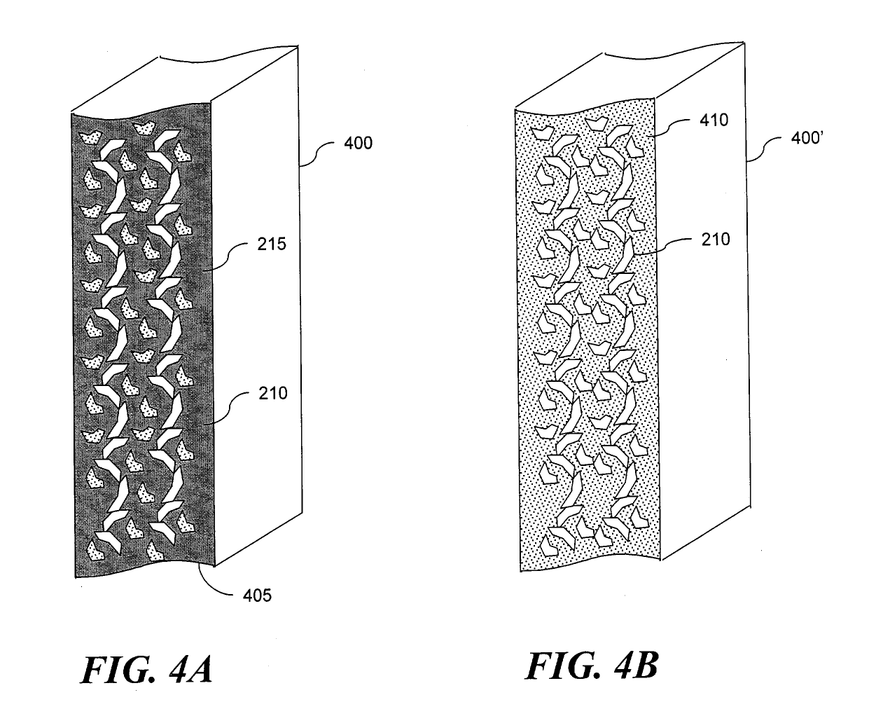

FIG. 4 illustrates a cross-sectional view of a solid material 400 including conductive particles 210 and absorptive particles 215. A third material 405 serves as a matrix to support the constituent particles 210, 215. The composition of the composite material 400 is similar to that already described in relation to FIG. 2A; however, the composite material 400 is formed in a free-standing manner not requiring a substrate for support. The matrix 405 may include an epoxy, and/or various polymers, such as silicone, rubber, EPDM, fluorosilicone, and POP.

FIG. 4B illustrates a cross-sectional view of a solid material 400′ including conductive particles 210 supported within an absorptive matrix 410. This embodiment is similar to that discussed in relation to FIG. 4A; however, a third material 405 is not required.

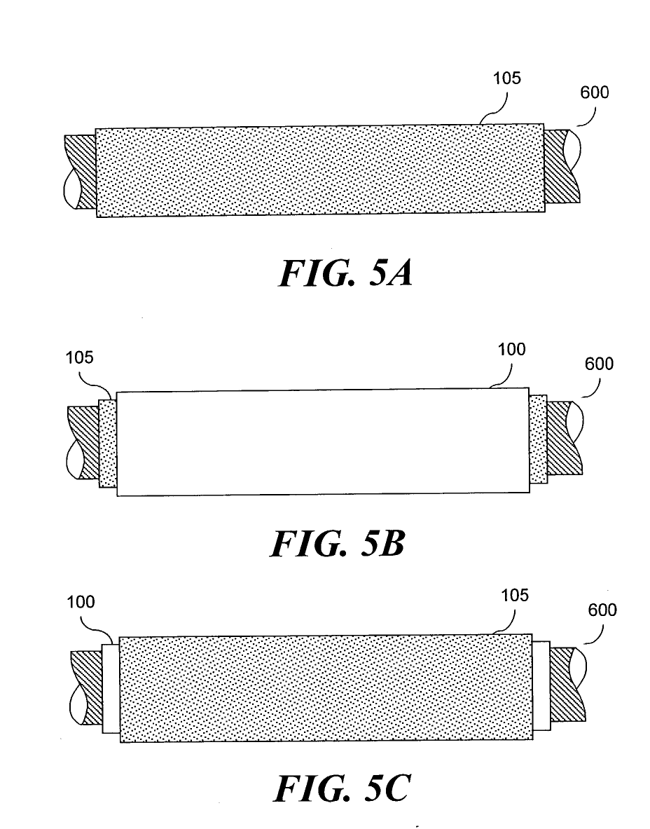

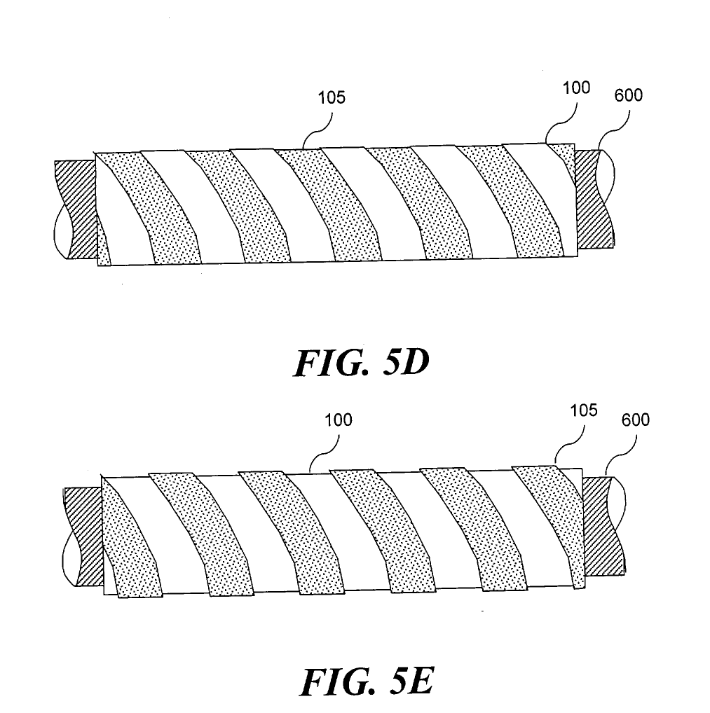

FIGS. 5A-5E illustrate alternative embodiments in which the conductive material 100 and absorptive material 105 may be applied to a cylindrical structure, such as a cable shield, conduit, or gasket. An absorptive layer 105 is applied to substantially coat an underlying structure, such as the cylindrical structure 600 illustrated in FIG. 5A. The absorptive layer 105 can be applied, for example, to an elastomer gasket to absorb electromagnetic energy that might otherwise penetrate the gasket. FIG. 5B illustrates an embodiment in which a conductive layer 100 is provided to shroud the absorptive-coated structure illustrated in FIG. 5A. FIG. 5C illustrates yet another embodiment in which a conductive layer 100 is first applied to the underlying structure 600, which is, in turn, shrouded by an absorptive layer 105. The underlying structure 600, such as the elastomer already discussed, may further contain conduits, wires, and/or cables (not shown).

The conductive material 100 and the absorptive material 105 may be applied to the underlying structure 600 in a predetermined pattern. Referring to FIG. 5D, for example, the absorptive layer 105 may be interspersed with the conductive layer 100, such as a double-helix pattern illustrated. Alternatively, the conductive layer may be applied in a pattern, such as a helix over a substantially continuous absorptive layer 105. FIG. 5E illustrates an embodiment in which an absorptive layer 105 is applied in a pattern, such as a helix, over a substantially continuous conductive layer 105.

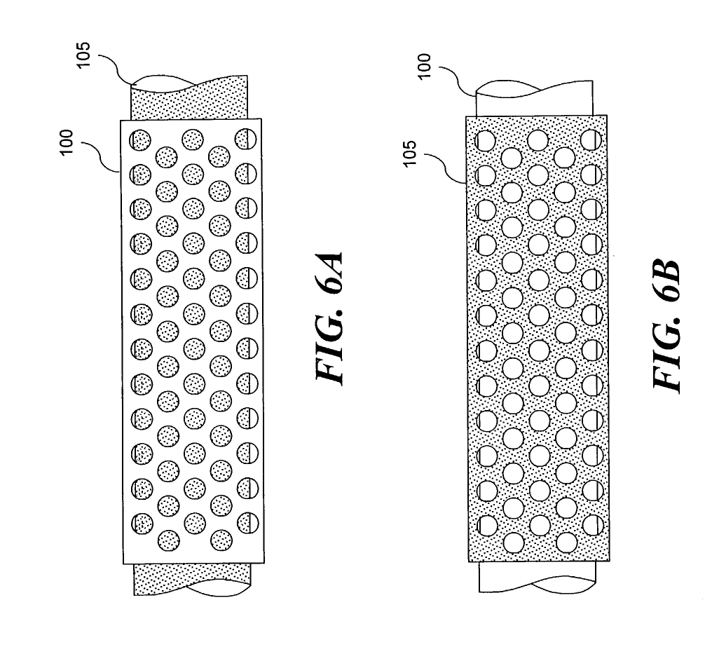

FIGS. 6A and 6B illustrate alternative embodiments including alternative application patterns of the conductive layer 100 over the absorptive layer 105 (FIG. 6A), and alternative application patterns of the absorptive layer 105 over the conductive layer (FIG. 6B). In either embodiment, the pattern may be formed as a screen, a weave, a fabric, and an open-cell foam.

The conductive layer 100 can be formed as a conductive gasket, such as a conductive screen, a conductive mesh, or a braid of conductive strands. The conductive layer 100 can also be formed as a conductive fabric, such as a conductive coated, or plated fabric. The absorptive layer 105 can be formed as a compressible material, such as an elastomer or foam impregnated with an absorbing filler. In one embodiment, the conductive layer 100 is formed as a conductive plated nylon yam over a foam absorptive layer 105.

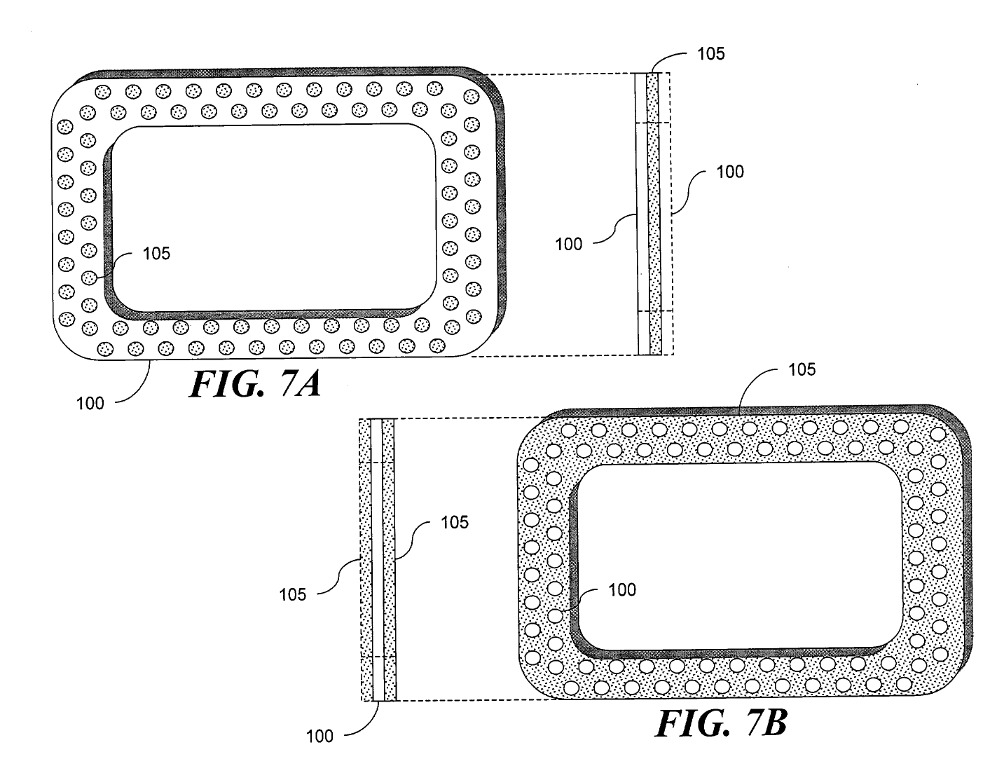

FIGS. 7A and 7B illustrate embodiments in which a conductive layer 100 and an absorptive layer 105 are combined to form a gasket. In some embodiments, the material layers 100, 105 completely cover each other. In other embodiments, portions of each of the material layers 100, 105 are exposed to the impinging EMI. As illustrated, the layers may only partially cover each other. As discussed in relation to FIGS. 3A through 3C, the layers may be combined with a substrate 200.

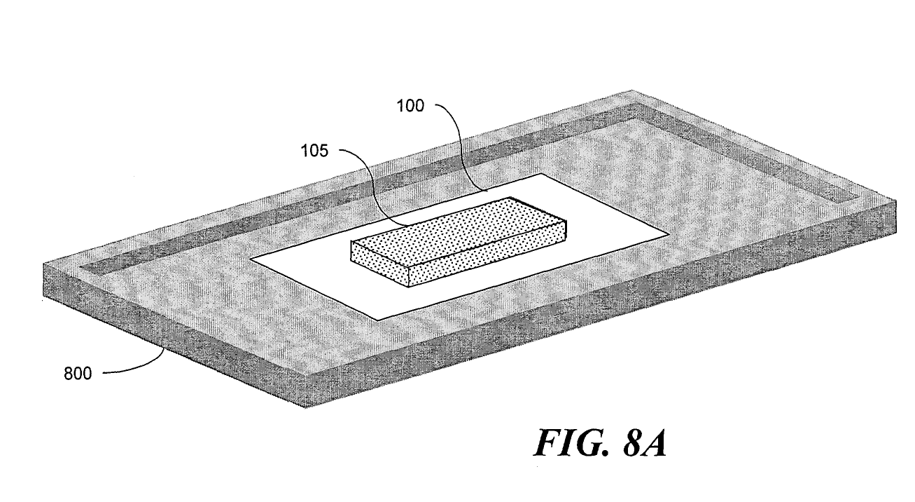

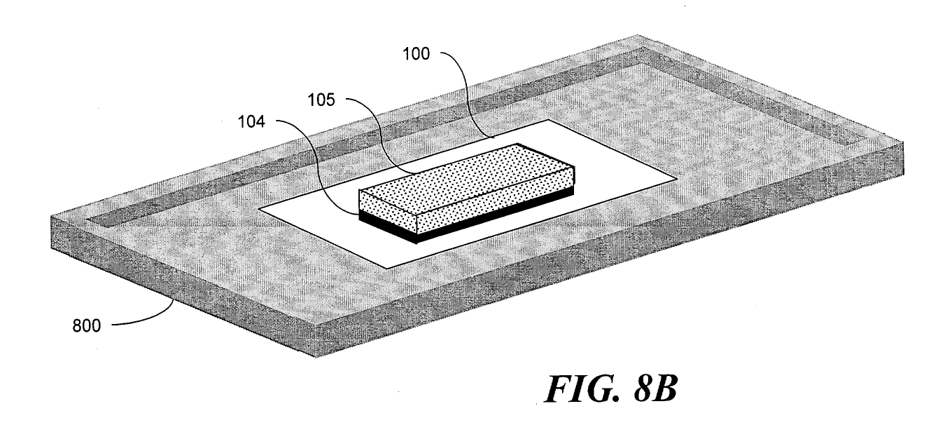

FIG. 8A illustrates an embodiment of a substrate, such as a plastic case 800, including a conducting layer 100 upon which is selectively applied an absorbing layer 105. This embodiment represents, for example, a portion of a cellular telephone case having an internal conductive shield 100 and selective absorptive shields 105 provided in relation to predetermined components to reduce EMI.

The constituent material layers 100, 105 can be applied during the manufacturing process, or, alternatively, they may be applied post-manufacturing. FIG. 8B illustrates an embodiment using a non-conductive, pressure-sensitive adhesive 104 to facilitate application of the lossy material 105 after the manufacturing process. For example, the lossy material 105 may be applied during board-level assembly, either before or after any application of conformal coating, during the system level assembly, or at any time post-installation. In this manner, the lossy material may be applied to any EMI enclosure, at any time. For example, interference due to EMI often first occurs, or is first evident, during, or shortly after, equipment installation or upgrade. It is typically during this time that the electromagnetic environment often changes in unpredictable ways; therefore, it is beneficial to mitigate EMI during a post-installation scenario, by particularly tailoring the application of the lossy material as necessary.

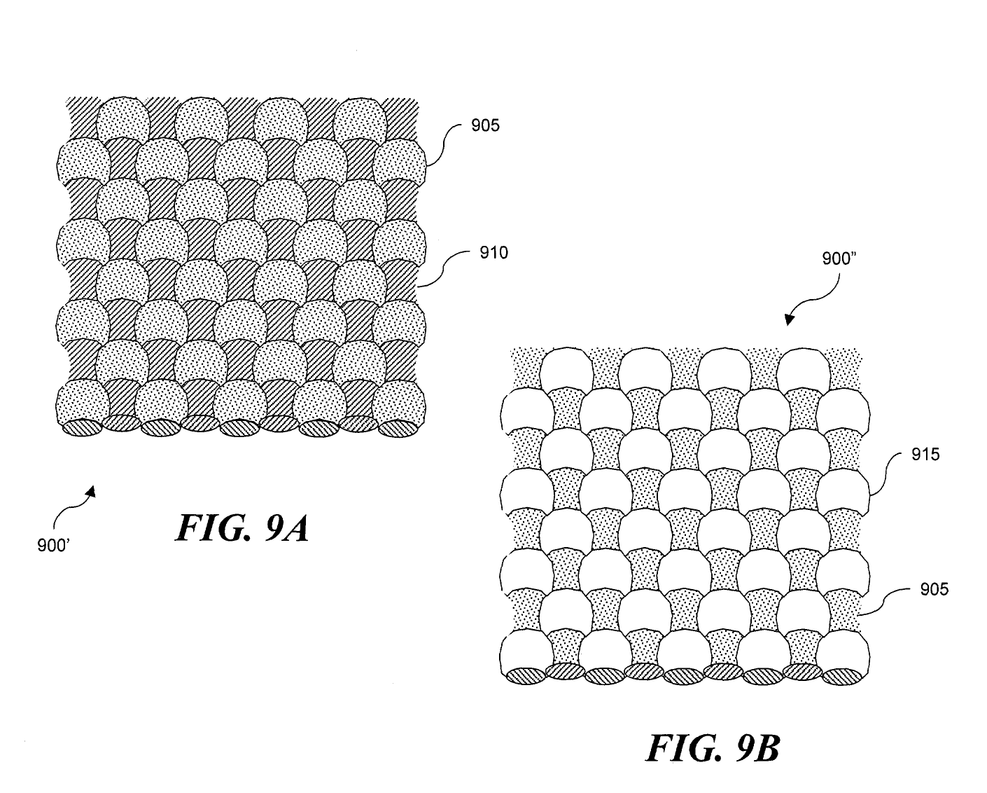

FIGS. 9A and 9B illustrate embodiments in which the composite shield 900′, 900″ (generally 900) is manufactured as a pliable material, such as a fabric or cloth. The fabric can be manufactured, for example, by weaving, felting, or knitting natural or synthetic fibers and filaments. Referring to FIG. 9A, a weave is formed by combining absorbing fibers or filaments 905 with other fibers or filaments 910. FIG. 9B illustrates an alternative fabric embodiment in which absorbing fibers 905 are combined in a weave together with conductive fibers 915. Yet other embodiments are possible in which the absorptive and conductive fibers 905, 915 are combined with other fibers or filaments 910 (not shown). The other fibers or filaments 910 may, for example, provide the fabric with other desirable attributes not directly related to EMI performance. For example, the other fibers 910 may provide desired attributes of strength, weight, moisture resistance, color, etc.

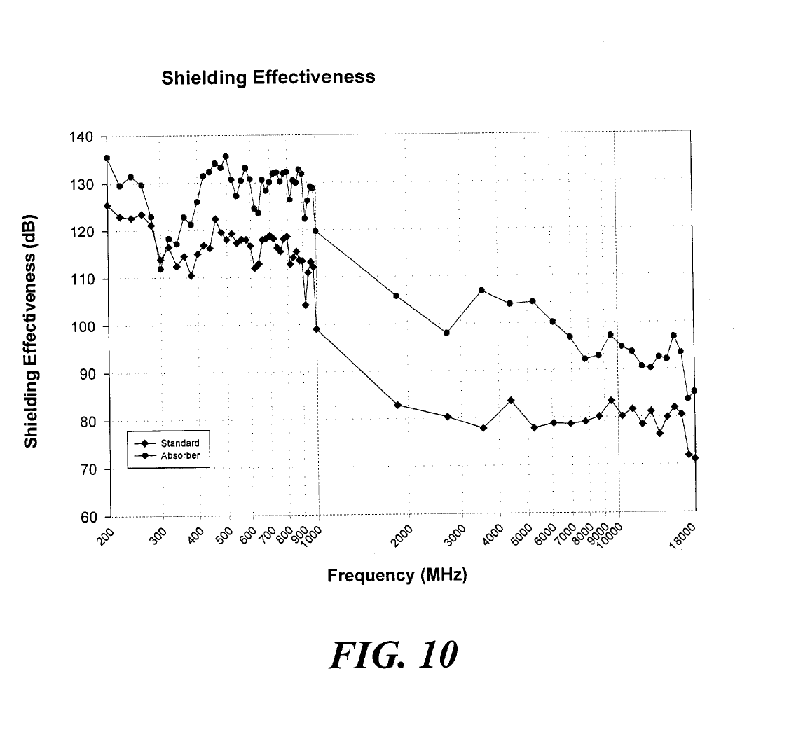

FIG. 10 illustrates test results relating to the EMI performance of a sample composite EMI shield as compared to a non-composite EMI shield. The composite EMI shield was formed as a compressible absorbing material wrapped by a flexible conducting material. The compressible absorbing material was prepared as an open cell foam coated with carbon. The flexible conducting material was prepared as a metal coated fabric,. The metal coating consisted of a nickel (Ni)-coated copper (Cu). Thus, the EMI shield was formed as an elongated compressible gasket having an absorptive foam core having uncompressed cross-sectional dimensions of approximately 0.25 inches by 0.25 inches, wrapped by a Ni—Cu plated nylon fabric.

The shielding effectiveness performance was measured for both the composite and non-composite shields in accordance with Military Detail Specification No. MIL-DTL-83528, entitled “Gasketing Material, Conductive, Shielding Gasket, Electronic, Elastomer, EMI/RFI, General Specification for,” Revision: C, Dated: Jan. 5, 2001. The shielding effectiveness measurements were performed over a modified frequency range from about 200 MHz to about 18 GHz. Generally, the composite EMI shield exhibited a shielding effectiveness of about 125 decibels (dB) at measurement frequencies below 1 GHz, representing about 10 dB greater values than those measured over the same frequency range for the non-composite EMI shield. At higher frequencies, the composite EMI shield exhibited a shielding effectiveness of greater than about 90 dB over most of the high frequency range, up to about 18 GHz. Again, the composite EMI shield exhibited shielding effectiveness values that were about 10 dB or higher than those exhibited by the non-composite EMI shield over the same frequency range.

Having shown exemplary and preferred embodiments, one skilled in the art will realize that many variations are possible within the scope and spirit of the claimed invention. It is therefor the intention to limit the invention only by the scope of the claims, including all variants and equivalents.

What is claimed is:

1. A broadband electromagnetic interference (EMI) shielding composite comprising:
a conductive material for shielding EMI by conducting at least a portion of incident EMI; and
an electromagnetic-energy absorptive material for shielding EMI by absorbing at least a portion of the incident EMI, the absorptive material combined with the conductive material, wherein each material retains its identity, while contributing to overall EMI shielding performance.

2. The composite of claim 1, wherein the conductive material comprises an electrically conductive material.

3. The composite of claim 1, wherein the conductive material and the absorptive material form respective layers in a predetermined pattern.

4. The composite of claim 3, wherein at least one of the layers is selectively deposited on a surface of a substrate.

5. The composite of claim 4, wherein at least one of the deposited layers is screen printed onto the substrate.

6. The composite of claim 5, wherein a remaining layer is selectively deposited on at least one of the surfaces of the substrate and the deposited layer.

7. The composite of claim 6, wherein at least a portion of each of the conductive material layer and the absorptive material layer is exposed.

8. The composite of claim 4, wherein at least one of the deposited layers is formed-in-place on the substrate.

9. The composite of claim 1, wherein the composite comprises particles of the conductive material and particles of the absorptive material combined in a binder matrix material supporting the combined conductive particles and absorptive particles.

10. The composite of claim 9, wherein the matrix is selected from the group consisting of epoxy, various polymers, silicone, rubber, EPDM, fluorosilicone, POP, open-cell foam, closed-cell foam, fabric, and combinations thereof.

11. The composite of claim 9, wherein the composite is selectively deposited on a surface of a substrate.

12. The composite of claim 1, wherein the energy absorptive material is selected from the group consisting of carbon-impregnated rubber, ferrite, iron, iron silicide, graphite, carbon in an organic-based carrier, paste composites, and combinations thereof.

13. The composite of claim 1, wherein the conductive material is selected from the group consisting of silver, nickel, copper, aluminum, steel, silver/glass, graphite, carbon, conductive polymers, and combinations thereof.

14. The composite of claim 1 comprising a shielding effectiveness of at least about 5 dB in a frequency range up to at least about 100 GHz.

15. A method for preparing a broadband electromagnetic interference (EMI) shielding composite comprising the steps of:
providing a conductive material for shielding EMI by conducting at least a portion of incident EMI; and
providing an electromagnetic energy absorptive material for shielding EMI by absorbing at least a portion of the incident EMI; and
combining the absorptive material with the conductive material, wherein each material retains its identity, while contributing to overall EMI shielding performance.

16. The method of claim 15, wherein the step of providing an electromagnetic energy absorptive material comprises the steps of:
providing a compressible dielectric matrix;
providing an electromagnetic energy absorptive particles; and
applying the electromagnetic energy absorptive particles to the compressible dielectric matrix.

17. The method of claim 16, wherein the step of applying the electromagnetic energy absorptive particles comprises spraying the electromagnetic energy absorptive particles onto the compressible dielectric matrix.

18. The method of claim 16, wherein the step of applying the electromagnetic energy absorptive particles comprises dipping the compressible dielectric matrix into a bath including the electromagnetic energy absorptive particles.

19. The method of claim 16, wherein the step of applying the electromagnetic energy absorptive particles comprises:
combining the dielectric matrix in a preformed state with the energy absorptive particles onto the compressible dielectric material matrix; and
forming the combination into a compressible electromagnetic energy absorbing material.

20. The method of claim 15, wherein the step of combining the absorptive material with the conductive material comprises applying a second layer of one of the conductive material and electromagnetic energy absorptive material to the surface of a first layer of the other one of the conductive material and electromagnetic energy absorptive materials.

21. The method of claim 16, further comprising the step of applying the first layer to a substrate.

22. A broadband electromagnetic interference (EMI) shielding composite comprising:
an compressible electromagnetic-energy absorber for shielding incident EMI by absorbing at least a portion of the EMI; and
a flexible conductor coupled to the absorber for shielding EMI by conducting at least a portion of incident EMI.

23. The composite of claim 22, wherein the flexible conductor comprises a conductive fabric.

24. The composite of claim 22, wherein the conductive fabric is selected from the group consisting of a woven fabric, a non-woven fabric, a ripstop fabric, a taffeta, and combinations thereof.
